(19) United States
(12) Patent Application Publication
(10) Pub. No.: US 2008/0284065 A1
(43) Pub. Date: Nov. 20, 2008

(54) PROCESS FOR CREATING A SKIN OR A COVERING ELEMENT PROVIDED WITH AT LEAST ONE ITEM ON ITS VISIBLE SURFACE

(76) Inventor: Denis Dutouquet, Thumeries (FR)

Correspondence Address: FRASER CLEMENS MARTIN & MILLER LLC, 28366 KENSINGTON LANE, PERRYSBURG, OH, 43551, US

(21) Appl. No.: 12/110,737

(22) Filed: Apr. 28, 2008

(30) Foreign Application Priority Data
May 16, 2007 (FR) 07 55095

(51) Int. Cl. B29C 45/16

(52) U.S. Cl. 264/511; 264/510

(57) ABSTRACT

A method for forming a covering for a motor vehicle interior is disposed wherein a kin is formed on a mold and non-visible surfaces of an item irremovably attached to the mold so that the skin is in the substantially same plane as a visible surface of the item.

### CROSS-REFERENCE TO RELATED APPLICATION

This application claims the benefit of French Application No. 0755095 filed May 16, 2007, hereby incorporated herein by reference in its entirety.

### FIELD OF THE INVENTION

This invention relates to the field of components for a vehicle compartment, and more particularly a process for creating a skin or a covering element provided with at least one item on its visible surface, the skin and the item work together to define a substantially even visible surface.

### BACKGROUND OF THE INVENTION

The outfitting of a vehicle compartment, such as an entire instrument panel, is often made of components with a skin covering that can be seen by the occupant of the vehicle. The exposed surface is usually called the visible surface and consequently should be designed to have an aesthetically pleasing appearance.

To improve the visual appearance of this type of component, the skin may include an add-in article or insert which may be seen by the vehicle's occupant. The known processes for producing skins provided with items are not completely satisfactory, since the transition area between each item and the skin are often uneven or are stopped by a mounting stud or another sub-component added during the assembly for the purpose of holding or keeping the add-in item in a particular position. Processes using means such as mounting studs to keep the article in place require supplementary steps to mount the articles, which increases the manufacturing time for the skin, molds adapted to the form of the item, and the mounting studs.

In other processes, there are also areas of transition which are broken up by a flange extruding out of the visible surface, or a groove, at the edge of the skin, adjacent to the item. The effect of this type of interruption degrades the aesthetic appearance of the component and/or causes premature wear. Also, dust or other contaminants may penetrate in the space between the skin and the add-in item, weakening the connection between the item and the skin and also sullying the aesthetic appearance of the covering.

It would be desirable to mitigate the above mentioned disadvantages and to propose a process for manufacturing a skin having a visible surface provided with at least one item in substantially the same plane and level as the item.

### SUMMARY OF THE INVENTION

A process for manufacturing a skin having a visible surface with at least one item in substantially the same place and level as the item, has surprisingly been discovered.

Furthermore, this process may be implemented using a mold without needing to be adapted to the item to be integrated.

For this purpose, the invention is a process for creating a skin or a covering element provided with at least one item on its visible surface characterized in that it consists of:
i) Applying a film on the visible surface of each item,
ii) Positioning each item, via its film, on the visible or functional surface of a mold,
iii) Wrapping a large part of each item with a skin in such a way that the latter will hold each item and that said skin and each item cooperate to define a visible or apparent surface that is very even along the transitional area between the skin and each item, the film being suitable to ensure a seal between the item concerned and the visible or functional surface of the mold to militate against a fluid, a resin, and a portion of the skin migrating therebetween and maintaining the aforementioned item on the visible or functional surface of the mold during stage iii) consisting in wrapping a substantial part of each item with a skin.

### BRIEF DESCRIPTION OF THE DRAWINGS

The invention will be better understood, due to the description below, relative to an embodiment, given as a non-restrictive example, and explained with reference to the attached schematic drawings, in which:

FIG. 1 shows a schematic cross-sectional view of an item supplied with a layer to be mounted on a visible surface of a skin according to an embodiment of the process of the invention;

FIG. 2 shows a schematic cross-sectional view of an item positioned, via the film, on a visible or functional surface of a mold, according to one stage of the process of the invention;

FIG. 3 shows a schematic cross-sectional view of the item positioned in the mold of FIG. 2 with a skin disposed over the item;

FIG. 4 shows a schematic cross-sectional view of an item positioned via a film, on a visible or functional surface of a mold with a skin applied thereto by a spraying operation according to another embodiment of the process of the invention;

FIG. 5 shows a schematic cross-sectional view of an item positioned, via a film, on a visible or functional surface of a mold with a skin applied thereto by a powder depositry operation accordingly to another Embodiment of the process of the invention; and

FIG. 6 shows a cross-sectional view of the skin provided with an insert obtained according to the embodiments of the process of this invention.

### DETAILED DESCRIPTION OF THE EMBODIMENTS

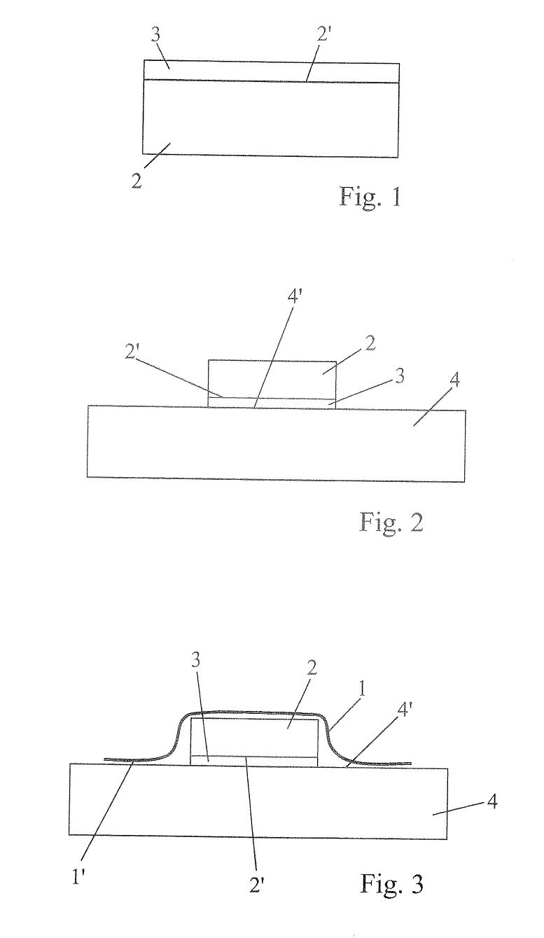

The process according to the invention of which certain stages are illustrated in FIGS. 1 to 3, is a process for creating a skin (1) or a covering element provided with at least one item (2) on its visible surface (2′). This process is characterized in that it consists of:
i) Applying a film (3) on the visible surface (2′) of each item (2),
ii) Positioning each item (2), via its film (3), on the visible or functional surface (4′) of a mold (4),
iii) Wrapping a large part of each item (2) with a skin (1) in such a way that the latter will hold each item (2) and that said skin (1) and each item (2) cooperate to define a visible or apparent surface (1′) that is very even along the transitional area between the skin (1) and each item (2), the film (3) being to ensure a seal between the item (2) concerned and the visible or functional surface (4′) of the mold (4) to militate against a fluid, a resin, and a portion of the skin migrating therebetween and maintaining the aforementioned item (2) on the visible or functional surface (4′) of the mold (4) during stage iii) consisting in wrapping a substantial part of each item (2) with a skin (1).

The process may end with a step in which the skin (1) provided with at least one item (2) is removed from the mold (4) and then the film (3) is removed. The film (3) will be removably adhered either to the visible or functional surface (4′) of the mold (4), or to the visible surface (2′) of the item (2), before stage iii) depending on the type of film (3) chosen. The fact that the film (3) is placed between the item (2) and the visible or functional surface (4′) of the mold (4) makes it possible to ensure that no material will come between or will fit between the item (2) and the visible or functional surface (4′) of the mold (4), so that the skin (1) covers only the non-visible surface of the item (2) or part of the latter. Additionally, because of the film (3), the item (2) remains in position during stage iii) of the process, namely the stage during which formation of the skin (1) is carried out. Under these conditions, each item (2) is correctly enveloped by the skin (1) and the appearance of the visible surface (1′) of the skin (1) provided with at least one item (2) is smooth, and planar, even in the transitional areas between the skin (1) and items (2), and is thus aesthetically pleasing.

The film (3) is selected from a type that may be removed very easily without leaving residue on the visible surface (2′) of the item (2), or on the visible or functional surface (4′) of mold (4).

Characteristically, the process may include applying a film (3) to be used as an adhesive.

Removably attaching the item (2) on the visible or functional surface (4′) of the mold (4) may also be carried out by magnetic attraction between the mold (4) and the item (2). To that end, the mold (4) and the item (2) may be made of a magnetic material. It is also possible to integrate a magnet into the internal structure of the mold (4) and another magnet in the item (2) or on the surface (2′) of the item (2) placed opposite to the visible or functional surface (4′) of the mold (4).

As an alternative, keeping each item (2) on the visible or functional surface (4′) of the mold (4) may also be carried out by magnetic attraction between the mold (4) and the film (3) made with a magnetic strip.

In order to facilitate removal of the film (3) from the item (2) after making a skin (1), the process may consist of applying a peelable film (3).

According to an embodiment of the invention as shown in FIG. 3, the process may incorporate a vacuum mold (4) to carry out stage iii) consisting of enveloping a substantial part of the item (2) with the skin (1) by aligning a preheated skin (1) above the vacuum mold (4) and by applying a vacuum force from the vacuum via the mold (4), so as to attract the skin (1) in order to put it in contact with the visible or functional surface (4′) of the mold (4) and with the non-visible surfaces of the item to be enveloped, so that the aforementioned skin (1) conforms to the contour of the non-visible surfaces of the item (2).

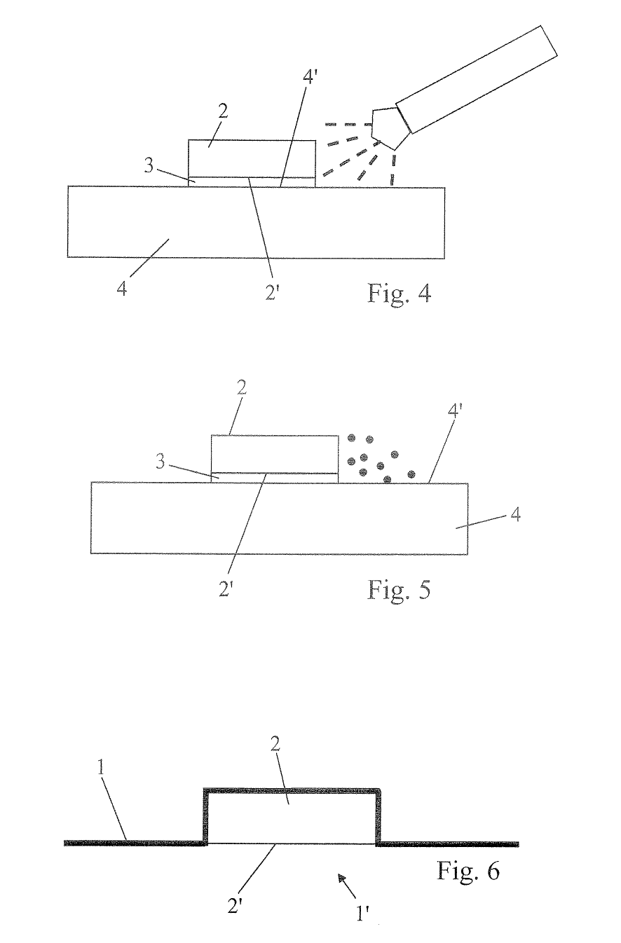

According to another embodiment of the invention and as shown in FIG. 4, the process may include a step for carrying out stage iii) consisting of enveloping a substantial part of each item (2) with a skin (1) by evenly spraying a liquid substance onto the visible or functional surface (4′) of the mold (4) and on the non-visible surfaces of the item (2) to envelope the items (2). The liquid substance may be polyurethane.

According to another embodiment of the process and shown in FIG. 5, the process may include a step for carrying out stage iii) consisting of enveloping a substantial part of each item (2) with the skin (1) by depositing a powder onto the visible or functional surface (4′) of the mold (4) and the non-visible surface of the item (2) during a rotational casting procedure. The powder may be made of materials chosen from polyurethanes and polyvinyl chlorides. The visible or functional surface (4′) of the mold (4) upon which the powder is deposited may be heated.

Each of the embodiments of the invention facilitate the formation of the skin (1) enclosing at least one item (2), at the level and plane of the transition between said item (2) and which is smooth and substantially planar, as shown in FIG. 6. The film (3) facilitates the removable attaching of the item (2) to the mold (4) to maintain the position of the item (2) during the creation of the skin (1), and to militate against the material forming the skin (1) from going between the visible surface (2′) of the item (2) and the visible or functional surface (4′) of the mold (4). The appearance of the visible surface (1′) of the skin (1) is thus aesthetically pleasing. Moreover, no space or grooves remain between the skin (1) and the item (2), i.e. no break in the surface of the transitional area between the skin (1) and each item (2), so that no impurity may slip into this area.

The invention is not limited to the embodiment described and shown in the attached drawings. Modifications remain possible, in particular from the point of view of the make up of the various items or by substituting technical equivalents, without completely departing from the field of invention protection.

What is claimed is:

1. A method of forming a covering for a motor vehicle interior comprising the steps of:
providing a mold having a functional surface;
providing an item having a visible surface and a non-visible surface;
removably attaching the item to the functional surface of the mold; and
applying a skin to the non-visible surface of the item and the functional surface of the mold.

2. The method of claim 1, wherein space between the skin and the item is minimized during the application of the skin thereon.

3. The method of claim 1, wherein a visible surface of the skin on the item and the visible surface of the item are in the substantially same plane.

4. The method of claim 1, wherein the skin is applied to the item in a vacuum mold.

5. The method of claim 1, wherein the skin is applied to the item with a spraying process.

6. The method of claim 5, wherein the skin is one of a polyurethane and a polyvinyl chloride.

7. The method of claim 1, wherein the skin is applied to the item with a powder depositing process.

8. The method of claim 7, wherein the skin is one of a polyurethane and a polyvinyl chloride.

9. The method of claim 1, wherein the item is removably attached to the functional surface of the mold by magnetic forces.

10. The method of claim 1, wherein the item is removably attached to the functional surface of the mold with a film applied on the visible surface of the item.

11. The method of claim 10, wherein the film is removable from the visible surface of the item.

12. The method of claim 10, wherein the film is one of an adhesive strip and a magnetic strip.

13. The method of claim 10, wherein the film creates a seal between the item and the functional surface of the mold.

14. A method of forming a covering for a motor vehicle interior comprising the steps of:
providing a mold having a functional surface;
providing an item having a visible surface and a non-visible surface;
applying a film to the visible surface of the item;
removably attaching the item to the functional surface of the mold; and
applying a skin to the non-visible surface of the item and the functional surface of the mold.

15. The method of claim 14, wherein the film creates a seal between the item and the functional surface of the mold.

16. The method of claim 14, wherein a visible surface of the skin and the visible surface of the item are in the substantially same plane.

17. The method of claim 14, wherein the skin is applied to the item in a vacuum mold.

18. The method of claim 14, wherein the skin is applied to the item with one of a spraying process and a powder depositing processing.

19. The method of claim 14, wherein the film is one of an adhesive strip and a magnetic strip.

20. A method of forming a covering for a motor vehicle interior comprising the steps of:
providing a mold having a functional surface;
providing an item having a visible surface and a non-visible surface;
applying a film to the visible surface of the item, wherein the film is one of an adhesive strip and a magnetic strip;
removably attaching the item to the functional surface of the mold; and
applying a skin to the non-visible surface of the item and the functional surface of the mold.
